(19) United States
(12) Patent Application Publication
(10) Pub. No.: US 2016/0123060 A1
(43) Pub. Date: May 5, 2016

(54) SWING LOCKING DEVICE FOR VEHICLE SLIDING DOOR

(71) Applicants: HYUNDAI MOTOR COMPANY, Seoul (KR); Kwangjin Co., Ltd., Asan-si (KR)

(72) Inventors: Jae Hong CHOI, Hwaseong-si (KR); YoungBae GONG, Asan-si (KR)

(21) Appl. No.: 14/878,964

(22) Filed: Oct. 8, 2015

(30) Foreign Application Priority Data
Nov. 3, 2014 (KR) 10-2014-0151237

(51) Int. Cl. E05D 15/58; B60J 5/06; E05C 19/02; B60J 5/04

(52) U.S. Cl. CPC E05D 15/58; B60J 5/047; B60J 5/06; E05C 19/02

(57) ABSTRACT

A swing locking device for a vehicle includes a central rail fixedly mounted at a sliding door for a vehicle, at least one slider coupled to the central rail to enable the central rail to be slid, a swing arm of which one end is rotatably connected to the at least one central slider and the other end is rotatably connected to a vehicle body, and a swing arm holder for restraining the pivot movement of the swing arm or releasing the swing arm.

### CROSS-REFERENCE TO RELATED APPLICATION

This application claims the benefit of priority to Korean Patent Application No. 10-2014-0151237, filed on Nov. 3, 2014, with the Korean Intellectual Property Office, the entire contents of which are incorporated herein by reference.

### TECHNICAL FIELD

The present disclosure relates to a swing locking device for a vehicle sliding door. More particularly, the present disclosure relates to a swing locking device for a vehicle swing door capable of temporary restraining and releasing a swing arm in order for a vehicle sliding door, which opens and closes a door opening of a vehicle body to forward and backward slidingly move in a longitudinal direction, to be smoothly pivoted and slid.

### BACKGROUND

In general, a vehicle is provided with a passenger area of a predetermined size in order to accommodate driver and accompanying passengers. Doors for opening and closing the passenger area are installed at the vehicle body.

The doors may comprise a front door disposed at the front along the longitudinal direction of the vehicle and a rear door disposed at the rear along the longitudinal direction of the vehicle. The front door and the rear door are installed at the vehicle body and are able to be rotated conventionally via a hinge.

In the case of a van, the doors for opening and shutting the passenger area open and close with a sliding movement forward and backward along the longitudinal direction of the van.

The sliding type doors for opening and shutting the passenger area of the van open the passenger area by moving rearwards along the longitudinal direction of the van and close the passenger room by moving forward along the longitudinal direction of the van. Accordingly, a smaller exterior space may be necessary to open and close the doors than a hinge type door.

In the conventional vehicle sliding door for opening/shutting the passenger area, the vehicle sliding door first pivots and then slidingly moves when opening the door, whereas the vehicle sliding door slidingly moves at first and then pivots when shutting the door. In the case when the vehicle sliding door performs such a swing movement and then slides, the structure that temporarily restrains the swing movement needed to not to be present during sliding movement in order for the sliding movement to be performed stably.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide a swing locking device for a vehicle sliding door having the advantages of improving the opening/shutting emotional quality and marketability of a vehicle sliding door for opening/shutting a door opening with making swing motion and sliding movement by that the vehicle sliding door can smoothly stably be slid by temporarily restraining swing motion not be simultaneously generated when the vehicle sliding door makes sliding movement.

A swing locking device for a vehicle according to an exemplary embodiment of the present disclosure may include a central rail fixedly mounted at a sliding door for a vehicle, at least one slider coupled to the central rail in order for the central rail to be slid, a swing arm of which one end is rotatably connected to the at least one central slider and the other end is rotatably connected to a vehicle body; and a swing arm holder for restraining the pivot movement of the swing arm or releasing the swing arm.

The at least one central slider may be mounted at a central slider mounting bracket to be moved together with the central slider mounting bracket.

One end of the swing arm may be connected to the central slider mounting bracket via pins, and the swing arm holder may be movably installed along the central slider mounting bracket.

A return spring may be further provided in order to return the swing arm holder to its original position.

One end of the return spring may be connected to the swing arm holder, and the other end thereof may be connected to the central slider mounting bracket.

The central rail may be fixedly mounted at the sliding door for a vehicle via a central rail mounting member; an operating link may be rotatably engaged to an end of the swing arm holder via pins; an operating space may be formed at the central rail mounting member in order for the operating link to be rotated; and a pressing protrusion may be further provided in order to press and rotate the operating link.

A guide groove for guiding the swing arm holder may be formed at the central slider mounting bracket.

A stop groove, at which the swing arm holder is pulled by the return spring and hanged, may be formed at the swing arm.

The stop groove may be formed in a shape of being depressed at the swing arm.

In accordance with the sliding door swing locking device for a vehicle according to an exemplary embodiment of the present disclosure, when the sliding door is opened, the sliding door is pivoted at first and then slides forward and backward in a longitudinal direction of a vehicle to open a door opening. Therefore, since the swing arm is locked by the swing holder supporting the sliding door to be swung at the time when the sliding door finishes the swing motion, the swing motion the sliding door is not generated simultaneously during slides in a longitudinal direction of a vehicle, such that the sliding door can be opened smoothly and softly and the opening/closing sensitive quality of the swing door can be improved.

When the sliding door is closed after opens the door opening, the locking state of the swing arm by the swing holder is consistently maintained, such that the sliding door can be smoothly slid in a longitudinal direction of a vehicle. After the sliding motion of the sliding door is finished, the locking state of the swing arm is released by the sliding door, such that the swing motion of the sliding door is smoothly made and the door opening is fully closed.

### BRIEF DESCRIPTION OF THE DRAWINGS

FIG. 1 is a perspective view of a sliding door device for a vehicle employing a swing locking device for a vehicle sliding door according to an exemplary embodiment of the present disclosure.

FIG. 2 is an upper perspective view of a central support structure.

FIG. 3 is a bottom perspective view of the central support structure.

FIG. 4 is a perspective view of the sliding door at the time when finishes the swing motion.

FIG. 5 is a bottom perspective view of FIG. 4.

FIG. 6 is a detailed schematic diagram of a swing locking device for a vehicle sliding door according to an exemplary embodiment of the present disclosure.

FIG. 7 is an essential enlarged perspective view of FIG. 6.

FIG. 8 is an operation diagram of a swing locking device for a vehicle sliding door according to an exemplary embodiment of the present disclosure when the sliding door is closed.

FIG. 9 is an operation diagram of a swing locking device for a vehicle sliding door according to an exemplary embodiment of the present disclosure at the time when the sliding door finishes the swing motion and starts the sliding motion thereof.

FIG. 10 is an operation diagram of a swing locking device for a vehicle sliding door according to an exemplary embodiment of the present disclosure at the time when the sliding door finishes the sliding motion thereof.

### DETAILED DESCRIPTION

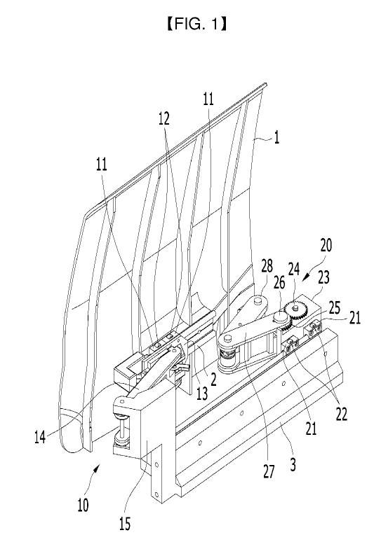

Hereinafter, an exemplary embodiment of the present disclosure will be described in detail with reference to the accompanying drawings. Referring to FIG. 1, a vehicle sliding door device employing a sliding door locking device for a vehicle sliding door according to an exemplary embodiment of the present disclosure may include a sliding door 1 opening and closing a door opening (not shown) formed at a vehicle body with a swing motion in a width and longitudinal direction and forward and backward sliding motion in a longitudinal direction of a vehicle; a central support structure 10 of which one end is connected to a central portion in a height direction of the sliding door 1 and the other end is connected to the vehicle body so that the sliding door 1 can make a relative swing motion and sliding motion to the vehicle body; a lower support structure 20 of which one end is connected to a lower portion in a height direction of the sliding door 1 and the other end is movably connected to the vehicle body so that the sliding door 1 can make a relative swing motion and sliding motion to the vehicle body.

A central rail 2 extended forward and backward in a longitudinal direction of a vehicle may be fixedly mounted at a central portion in a height direction of the sliding door 1. The central support structure 10 may include at least one central slider 11 which is mounted at the central rail 2 so as to be rolled and supports the central rail 2 and the sliding door 1 to be slid.

The at least one central slider 11 may include a plurality of rollers 12 which can roll with closely contacted to the central rail 2.

The at least one central slider 11 may be fixedly mounted at a central slider mounting bracket 13.

One end of a swing arm 14 may be rotatably connected to the central slider mounting bracket 13 via pins and the other end of the swing arm 14 may be rotatably connected to a vehicle body mounting bracket 15 mounted on the vehicle body via pins.

A lower rail 3 extended forward and backward in a longitudinal direction of a vehicle may be fixedly mounted at the vehicle body.

The lower support structure 20 may include at least one lower slider 21 mounted on the lower rail 3 to be rolled in order to support the lower rail 3 and the sliding door 1 to be slid.

The at least one lower slider 21 may include a plurality of rollers 22 which can roll in close contact with the lower rail 3.

The at least one lower slider 21 may be fixedly mounted at a housing 23. An input gear 24 may be rotatably installed at an upper portion of the housing 23 via a gear shaft. A planetary gear set, which receives rotational movement through the gear shaft and increases rotation speed at an output, may be installed inside of the housing 23.

A transmission gear 25 may be installed to engage with the input gear 24. A gear shaft 26 of the transmission gear 25 may be connected to one end of a first link 27. The other end of the first link 27 may be connected to a second link 28 via pins. The other end of the second link 28 may be connected to the sliding door 1 via pins.

The first and second links 27, 28 and gears may aid in supporting a lower portion of the sliding door 1 when pivoted and slid.

FIG. 1 shows a state where the sliding door 1 closes and seals the door opening formed at the vehicle body.

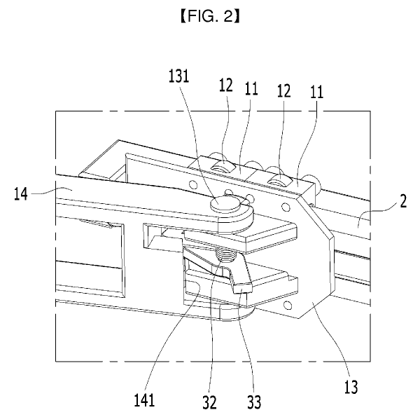

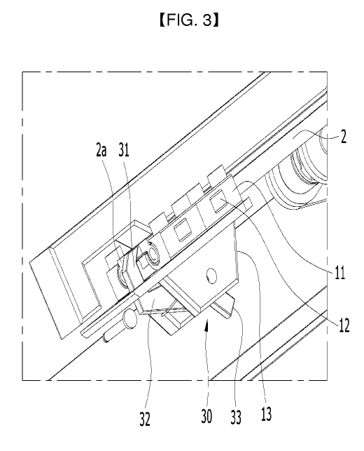

Referring to FIG. 2 and FIG. 3, one end of the swing arm 14 may be rotatably connected to the central slider mounting bracket 13 via pin 131.

The pin 131 may be engaged to a hook 30 so that the hook 30 can be rotatably supported by the pin 131.

In order to return the hook 30 to its original position after being rotated, a return spring 32 may be connected to the hook 30.

A hanger loop 31 may be formed at an end of the hook 30. The hanger loop 31 may aid in fixing the central slider 11 and the central slider mounting bracket 13 to the central rail 2 or in releasing the central slider 11 and the central slider mounting bracket 13 from the central rail 2.

FIG. 2 and FIG. 3 show a state where the hanger loop 31 of the hook 30 is hanged at an end portion 2a of the central rail 2 such that the central rail 2 and the central slider 11 are restrained relative to each other.

A pressing edge 141 may be formed at an end portion with which the swing arm 14 is engaged via the pin 131.

The pressing edge 141 may aid in pressing a hook body 33 of the hook 30 according to the rotational motion of the swing arm 14 and rotating the hook 30 around the pin 131.

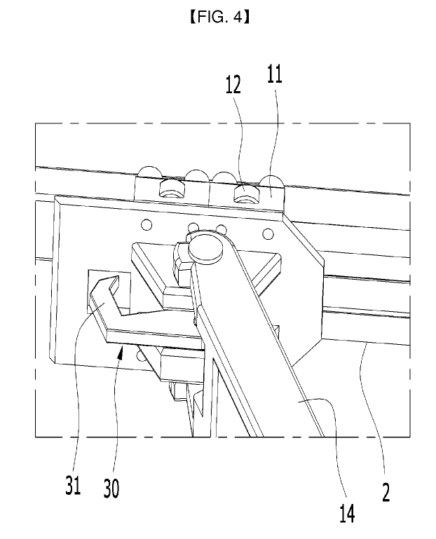

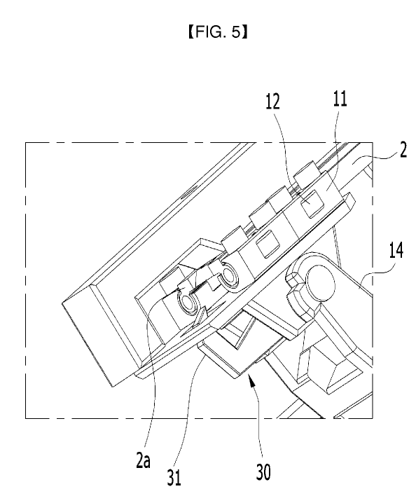

Referring to FIG. 4 and FIG. 5, the swing arm 14 may rotate about 90 degrees according to the swing motion of the sliding door 1, and the pressing edge 141 of the swing arm 14 presses the hook 30 to rotate the hook 30, such that the central rail 2 and the central slider 11 are released relative to each other.

In this state, the central rail 2 can slide when inserted into the central slider 11.

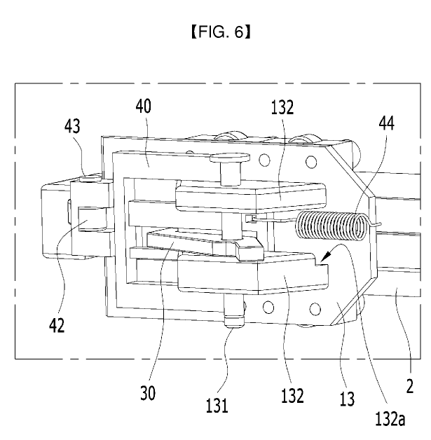

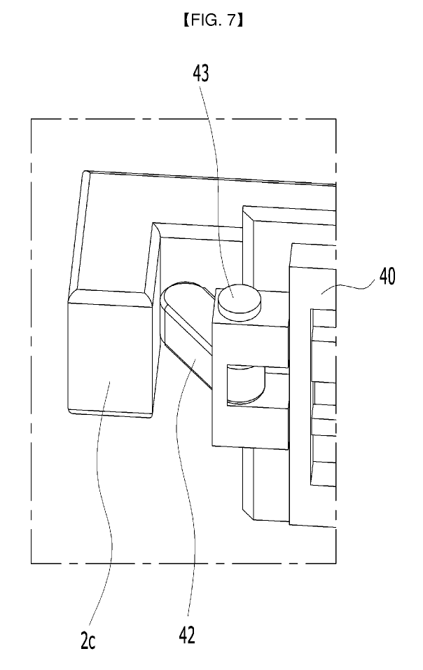

Referring to FIG. 6 and FIG. 7, two flanges 132 protruding toward a passenger compartment may be formed at the central slider mounting bracket 13 at a predetermined gap in a height direction with each other.

The pin 131 may penetrate and may be engaged with the two flanges 132.

A swing arm holder 40 for selectively restraining or releasing the swing arm may be movably installed at the central slider mounting bracket 13.

An operating link 42 may be engaged with an end of the swing arm holder 40 via a pin 43.

In order to return the swing arm holder 40 to its original position, one end of a return spring 44 may be connected to the swing arm holder 40 and the other end thereof may be connected to the central slider mounting bracket 13.

A guide groove 132a with concave shape may be formed at a lower end portion of the two flanges 132.

The guide groove 132a may aid in guiding the sliding motion of the swing arm holder 40.

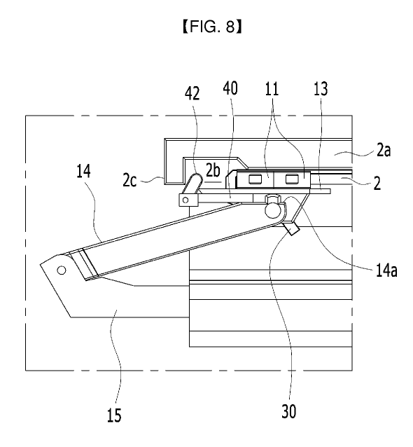

Referring to FIG. 8, a central rail mounting member 2a for mounting the central rail 2 may be fixedly attached at the sliding door 1. An operation space 2b, which is shaped in a direction of reducing the thickness of the central rail mounting member 2a, may be formed at a front portion of the central rail mounting member 2a. A pressing protrusion 2c for pressing the operating link 42 may be formed at a front end portion of the central rail mounting member 2a and protrude toward the passenger compartment.

The operation space 2b may provide the space where the operating link 42 and the hook 30 can be operated.

FIG. 8 shows a position of the swing arm holder 40 in a state where the sliding door 1 is fully closed.

The operating link 42 of the swing arm holder 40 may be inserted and fixed between the end portions of the pressing protrusion 2c and the central slider mounting bracket 13, and the return spring 44 of the swing arm holder 40 is in a pulled state such that the elastic restoring force of the return spring 44 acts on the swing arm holder 40. However, since the operating link 42 of the swing arm holder 40 is inserted and fixed between the pressing protrusion 2c and the central slider mounting bracket 13, the swing arm holder 40 does not move toward the swing arm 14 even though the swing arm holder 40 receives the elastic restoring force of the return spring 44.

A stop groove 14a may be formed at the swing arm 14 shaped in a radial inside direction.

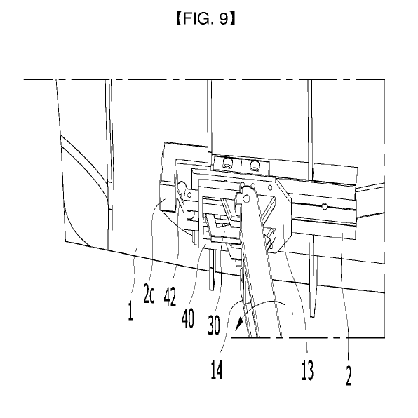

Referring to FIG. 9, if a user pulls the sliding door 1 outward in a width direction of a vehicle in order to open the sliding door 1, the sliding door 1 performs a swing motion outward in the width direction of a vehicle while supported by the swing arm 14. During this swing motion of the sliding door 1, the hook is hanged at the central rail 2 and not operated, such that the sliding door 1 does not perform a sliding motion, but only performs a swing motion. When the sliding door 1 finishes the swing motion, that is, after the swing arm 14 does swing motion about 90 degrees, the hook 30 is pressed by the swing arm 14 and rotated to release the locked state of the central slider 11 and the central rail 2, such that the swing motion between the central rail 2 and the central slider 11 is enabled.

In this state, if the user pushes the sliding door 1 forward (front door) or backward (rear door) in a longitudinal direction of a vehicle, the central rail 2 of the sliding door 1 slide together with the sliding door 1 while supported by the central slider 11. By the sliding motion of the sliding door 1, the pressing protrusion 2c mounted at the sliding door 1 moves together with the sliding door 1 such that the gap between the pressing protrusion 2c and the central slider mounting bracket 13 is widened. Also, by the elastic restoring force of the return spring 44, the swing arm holder 40 is pulled toward the swing arm 14 and hanged at the stop groove 14a of the swing arm 14 such that the swing arm 14 can no longer be rotated clockwise.

Therefore, the sliding door 1 can smoothly perform only a sliding motion when supported by the swing arm 14.

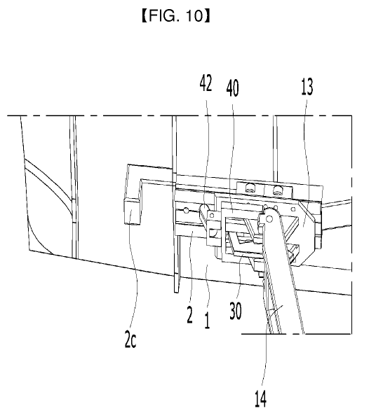

FIG. 10 shows a state where the sliding door 1 has finished the sliding motion and fully opened the door opening.

The swing arm holder 40 is still pulled toward the swing arm 14 by the elastic restoring force of the return spring 44 and is inserted into the stop groove 14a of the swing arm 14 to be coupled thereto.

In this state, since the swing arm 14 is still restrained by the swing arm holder 40 even when the sliding door is closed, the sliding door 1 can only perform the sliding motion.

When the sliding motion of the sliding door 1 is almost finished, the pressing protrusion 2c of the sliding door 1 presses down the operating link 42 such that the operating link 42 rotates clockwise around the pin 43 to pull the swing arm holder 40. As the result, the swing arm holder 40 releases from the stop groove 14a of the swing arm 14 and the return spring 44 is pulled by the swing arm 40 to return to a tension state again.

If the sliding door 1 fully closes the door opening, the sliding door 1 returns to the state shown in FIG. 8.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A swing locking device for a vehicle, comprising:
a central rail fixedly mounted at a sliding door for a vehicle;
at least one slider coupled to the central rail to enable the central rail to be slid;
a swing arm of which one end is rotatably connected to the at least one central slider and the other end is rotatably connected to a vehicle body; and
a swing arm holder for restraining the pivot movement of the swing arm or releasing the swing arm.

2. The swing locking device for a vehicle of claim 1, wherein the at least one central slider is mounted at a central slider mounting bracket and moved together with the central slider mounting bracket.

3. The swing locking device for a vehicle of claim 2, wherein one end of the swing arm is connected to the central slider mounting bracket via pins, and
the swing arm holder is movably installed along the central slider mounting bracket.

4. The swing locking device for a vehicle of claim 3, wherein a return spring is further provided in order to return the swing arm holder to an original position.

5. The swing locking device for a vehicle of claim 4, wherein one end of the return spring is connected to the swing arm holder, and the other end thereof is connected to the central slider mounting bracket.

6. The swing locking device for a vehicle of claim 3, wherein the central rail is fixedly mounted at the sliding door for a vehicle via a central rail mounting member, an operating link is rotatably engaged to an end of the swing arm holder via pins, an operating space is formed at the central rail mounting member in order for the operating link to be rotated, and a pressing protrusion is further provided in order to press and rotate the operating link.

7. The swing locking device for a vehicle of claim 2, wherein a guide groove for guiding the swing arm holder is formed at the central slider mounting bracket.

8. The swing locking device for a vehicle of claim 4, wherein a stop groove, at which the swing arm holder is pulled by the return spring and hanged, is formed at the swing arm.

9. The swing locking device for a vehicle of claim 8, wherein the stop groove is formed in a shape of being depressed at the swing arm.
